(19) United States
(12) Patent Application Publication
(10) Pub. No.: US 2021/0214050 A1
(43) Pub. Date: Jul. 15, 2021

(54) LIQUEFIED NATURAL GAS VESSEL

(71) Applicant: FlexScale LNG, Inc., Washington, DC (US)

(72) Inventors: Eftychis John Gregos-Mourginakis, Washington, DC (US); William Stephen Fisher, Jacksonville, FL (US); Rami Abousoufeh, Jacksonville, FL (US)

(73) Assignee: FlexScale LNG, Inc., Washington, DC (US)

(21) Appl. No.: 17/145,635

(22) Filed: Jan. 11, 2021

Related U.S. Application Data
(60) Provisional application No. 62/959,289, filed on Jan. 10, 2020.

(51) Int. Cl. B63B 25/14; B63B 25/16; F25J 1/00

(52) U.S. Cl. CPC B63B 25/14; F25J 1/0277; F25J 1/0025; B63B 25/16

(57) ABSTRACT

A new LNG vessel for carrying smaller shipments of LNG to locations that have limited access including rivers and shallow harbors with a low water depth, with a capability to handle boil-off gas, is described. The LNG vessel includes a bilobe or other C-type LNG storage tank, at least one LNG vaporizer, at least one water pump, and at least one LNG pump system on the main cargo platform. The LNG vessel further includes a system for re-condensing boil-off gas.

### CROSS-REFERENCE TO RELATED APPLICATIONS

This application claims priority to U.S. Provisional Application Ser. No. 62/959,289, filed Jan. 10, 2020, the content of which is incorporated herein by reference in its entirety.

### FIELD

Embodiments of the present disclosure generally relate to liquefied natural gas and the marine transportation thereof.

### BACKGROUND

Generally, natural Gas (NG) is turned into a liquid (also called liquefied natural gas or LNG) in a liquefaction plant, transported over a long distance by an LNG carrier, and re-gasified by passing a floating storage and re-gasification unit (FSRU) or an unloading terminal on land to be supplied to consumers.

LNG can also be transported by an LNG re-gasification vessel (LNG-RV), in which LNG is re-gasified in the LNG-RV itself and then supplied directly to consumers, and does not pass a FSRU or an unloading terminal on land.

As liquefaction of natural gas occurs at a cryogenic temperature of approximately −163° C. at ambient pressure, LNG is likely to be vaporized even when the temperature of the LNG is slightly higher than −163° C. at ambient pressure. Although an LNG carrier has a thermally insulated LNG storage tank, as heat is continually transferred from the outside to the LNG in the LNG storage tank, the LNG is continually vaporized and boil-off gas (BOG) is generated in the LNG storage tank during the transportation of LNG. If boil-off gas is generated in an LNG storage tank as described above, the pressure of the LNG storage tank is increased and becomes dangerous.

Generally, to maintain a constant pressure within the LNG storage tank for an LNG carrier, the boil-off gas generated in the LNG storage tank is consumed as a fuel for propulsion of the LNG carrier. That is to say, LNG carriers for transporting LNG basically maintain the temperature of the LNG in the LNG storage tank at approximately −163° C. at ambient pressure by discharging the boil-off gas to the outside of the tank.

For example, a steam turbine propulsion system driven by the steam generated in a boiler can burn the boil-off gas generated in an LNG storage tank. In addition, a dual fuel diesel electric propulsion system can use the boil-off gas generated in an LNG storage tank as a fuel for a diesel engine after compressing the boil-off gas.

There are systems for re-liquefying the boil-off gas generated in an LNG storage tank and returning the re-liquefied boil-off gas to the LNG storage tank. However, to avoid wasting boil-off gas when the amount of boil-off gas generated in an LNG storage tank exceeds the capacity of a propulsion system or a boil-off gas re-liquefaction plant, there is a need for an improved vessel and system for receiving the boil-off gas and re-condensing the boil-off gas.

In addition, conventional LNG carriers are tank ships designed to transport larger LNG cargoes. For example, some conventional LNG carriers have a capacity of around 145,000 m³ and about 265,000 m³. However, these conventional LNG carriers are not capable of accessing rivers and shallow harbors due to draft restrictions and other issues with their maneuverability and length. Therefore, there is a need for an improved vessel that has a smaller carrying capacity and a re-designed configuration such that it is capable of transporting LNG to locations that have limited access including rivers and shallow harbors with a low water depth, e.g., a draft of 6 meters or less.

### SUMMARY

A new LNG vessel for carrying smaller shipments of LNG to locations that have limited access including rivers and shallow harbors with a low water depth, with a capability to handle boil-off gas, is described. According to some embodiment of the present disclosure, the LNG vessel can include a bilobe or other C-type LNG storage tank, at least one LNG vaporizer, at least one water pump, and at least one LNG pump system on the main cargo platform, wherein the LNG pump system is configured to load and offload LNG in the bilobe or other C-type LNG storage tank, and the one or more LNG vaporizer and the one or more water pump is configured to re-gasify LNG loaded in the bilobe or other C-type LNG storage tank.

According to some embodiments of the present disclosure, the vessel can include two LNG vaporizers, wherein a first LNG vaporizer is positioned on a port side of the vessel and the second LNG vaporizer is positioned on a starboard side of the vessel.

According to some embodiments of the present disclosure, the vessel can include two water pumps, wherein the first water pump is positioned on the port side of the vessel and the second water pump is positioned on a starboard side of the vessel.

According to some embodiments of the present disclosure, the vessel can include two LNG pump systems, wherein the two LNG pump systems are positioned at a stern of the vessel.

According to some embodiments of the present disclosure, the bilobe or other C-type LNG storage tank can be adapted to withstand pressure up to about 1.0 barg to about 12 barg.

According to some embodiments of the present disclosure, the bilobe or other C-type LNG storage tank can include an inner vessel, a vacuum composite insulation, and an outer vessel.

According to some embodiments of the present disclosure, the bilobe or other C-type LNG storage tank can include a BOG nozzle and a plurality of sprinklers.

According to some embodiments of the present disclosure, the plurality of LNG sprinklers can be disposed in a line along an upper portion of the bilobe or other C-type LNG storage tank.

According to some embodiments of the present disclosure, the BOG nozzle can be disposed in a lower portion of the bilobe or other C-type LNG storage tank.

According to some embodiments of the present disclosure, the vessel further can include a system for re-condensing BOG.

According to some embodiments of the present disclosure, a vessel including a system for re-condensing BOG is provided. The system for re-condensing BOG can include: a first valve configured to provide fluid communication between a storage tank of a LNG carrier to a first set of flexible or rigid connections, a second valve configured to provide fluid communication between the storage tank of the LNG carrier to a second set of flexible or rigid connections, wherein the first set of flexible or rigid connections is configured to transfer BOG by a blower from the storage tank of the LNG carrier to be deposited in the bilobe or other C-type LNG storage tank through a BOG injection nozzle, and the second set of flexible or rigid connections is configured to transfer LNG from the storage tank of the LNG carrier to be deposited in the bilobe or other C-type LNG storage tank by a plurality of sprinklers.

According to some embodiments of the present disclosure, the storage tank of the LNG carrier can be configured to withstand pressure of about 0.25 barg.

According to some embodiments of the present disclosure, the storage tank of the LNG carrier can be configured to withstand pressure of about 0.70 barg.

According to some embodiments of the present disclosure, the storage tank can include an initial cargo of LNG.

According to some embodiments of the present disclosure, the blower can be configured to transfer BOG from the storage tank on the LNG carrier to a lower portion of the bilobe or other C-type LNG storage tank, increasing increase pressure in the bilobe or other C-type LNG storage tank to about 1.0 barg to about 12 barg.

According to some embodiments of the present disclosure, a transfer pump can be configured to transfer LNG from the storage tank on the LNG carrier to an upper portion of the bilobe or other C-type LNG storage tank.

According to some embodiments of the present disclosure, the plurality of sprinklers can be configured to sprinkle LNG transferred from the LNG carrier from an upper portion of the bilobe or other C-type LNG storage tank down on a lower portion of the bilobe or other C-type LNG storage tank when the pressure in the bilobe or other C-type LNG storage tank reaches about 1.0 barg to about 12 barg, thereby re-condensing BOG into liquid form.

According to some embodiments of the present disclosure, the bilobe or other C-type LNG storage tank can be reduced to a pressure of about 0.3 barg after BOG is re-condensed into liquid form.

According to some embodiments of the present disclosure, a system for re-condensing BOG is provided. The system for re-condensing BOG can include: a first storage tank configured to withstand pressure up to about 1.0 barg to about 12 barg, a second storage tank configured to withstand a pressure lower than the first storage tank, a first valve configured to provide fluid communication between a storage tank of a LNG carrier to a first set to a first set of flexible or rigid connections, a second valve configured to provide fluid communication between the storage tank of the LNG carrier to a second set of flexible or rigid connections, the first set of flexible or rigid connections configured to transfer BOG from the second storage tank to be deposited in the first storage tank, and the second set of flexible or rigid connections configured to transfer LNG from the second storage tank to be deposited in the first storage tank.

According to some embodiments of the present disclosure, the BOG nozzle can be configured to deposit BOG in the lower portion of the first storage tank.

According to some embodiments of the present disclosure, the first storage tank can include a plurality of sprinklers disposed in an upper portion of the first storage tank.

According to some embodiments of the present disclosure, the plurality of sprinklers can be configured to sprinkle LNG transferred from the second storage tank from an upper portion of the first storage tank down on a lower portion of the first storage tank when the pressure in the first LNG storage tank reaches about 1.0 barg to about 12 barg, thereby re-condensing BOG into liquid form and reducing pressure in the first storage tank.

According to some embodiments of the present disclosure, the system can further include a blower configured to transfer BOG from the second storage tank to a lower portion of the first storage tank, increasing pressure in the first storage tank to about 1.0 barg to about 12 barg.

According to some embodiments of the present disclosure, the first storage tank can include an initial cargo of LNG.

According to some embodiments of the present disclosure, the first storage tank can be a bilobe or other C-type LNG storage tank.

According to some embodiments of the present disclosure, the second storage tank can be configured to withstand a pressure of about 0.25 barg.

According to some embodiments of the present disclosure, the second storage tank can be configured to withstand a pressure of about 0.7 barg.

According to some embodiments of the present disclosure, the system can further include a transfer pump configured to transfer LNG from the second storage tank to an upper portion of the first storage tank.

According to some embodiments of the present disclosure, a method for re-condensing BOG is provided. The method can include transferring BOG from a second storage tank configured to withstand lower pressure than a first LNG tank to a lower portion of the first LNG tank, transferring LNG to an upper portion of the first LNG tank, and dispersing the transferred LNG from the upper portion of the first LNG tank down on the lower portion of the first LNG storage tank, thereby re-condensing the transferred BOG back into liquid form.

According to some embodiments of the present disclosure, the first LNG tank can be configured to withstand a pressure of about 1.0 barg to about 12 barg.

According to some embodiments of the present disclosure, the second storage tank can be configured to withstand a pressure of about 0.25 barg.

According to some embodiments of the present disclosure, the second storage tank can be configured to withstand a pressure of about 0.7 barg.

According to some embodiments of the present disclosure, the second storage tank can be disposed on a LNG carrier.

According to some embodiments of the present disclosure, the first LNG tank can be disposed on a main cargo platform of a LNG vessel along with at least one LNG vaporizer, at least one water pump, and at least one LNG pump system.

According to some embodiments of the present disclosure, transferring BOG to the first LNG tank increases a pressure in the bilobe or other C-type LNG tank to about 1.0 barg to about 12 barg.

According to some embodiments of the present disclosure, transferring LNG to the first LNG tank can be performed when a pressure in the first LNG tank is about 1.0 barg to about 12 barg.

According to some embodiments of the present disclosure, dispersing the transferred LNG to re-condense BOG reduces a pressure in the first LNG tank.

According to some embodiments of the present disclosure, transferring BOG to the lower portion of the first LNG tank can include using a blower to transfer BOG from the second storage tank through a first set of flexible and rigid connections configured to provide fluid communication to the lower portion of the first LNG tank.

According to some embodiments of the present disclosure, transferring LNG to the upper portion of the first LNG tank can include using a transfer pump to transfer LNG from the second storage tank through a valve and a second set of flexible and rigid connections configured to provide fluid communication with the upper portion of the first LNG tank.

According to some embodiments of the present disclosure, dispersing the transferred LNG from the upper portion of the first LNG storage tank can include using a plurality of sprinklers disposed on the upper portion of the first LNG tank.

According to some embodiments of the present disclosure, the first LNG tank can be a bilobe or other C-type LNG tank.

Other features and advantages of embodiments of the present disclosure will be apparent from the accompanying drawings and from the detailed description that follows.

### BRIEF DESCRIPTION OF THE DRAWINGS

Embodiments of the present disclosure are illustrated by way of example and not limitation in the figures of the accompanying drawings, in which like references indicate similar elements.

FIG. 1 illustrates a top view of the liquefied natural gas vessel according to some embodiments of the present disclosure.

FIG. 2 illustrates a side view of the liquefied natural gas vessel according to some embodiments of the present disclosure.

FIG. 3 illustrates a cross-section view of the LNG storage tank of the liquid natural gas vessel according to some embodiments of the present disclosure.

FIG. 4 illustrates a schematic diagram of the system for re-condensing boil-off gas according to some embodiments of the present disclosure.

FIG. 5 illustrates a flow chart of the method for re-condensing boil-off gas according to some embodiments of the present disclosure.

FIG. 6 illustrates a schematic diagram of the system for re-gasifying LNG according to some embodiments of the present disclosure.

FIG. 7 illustrates a schematic diagram for a system for transferring LNG from a LNG carrier to the LNG vessel according to some embodiments of the present disclosure and providing the regasified natural gas to onshore facilities.

FIG. 8 illustrates a schematic diagram for a system for transferring LNG from a LNG carrier to the LNG vessel according to some embodiments of the present disclosure.

FIG. 9 illustrates a schematic diagram for a system for transferring LNG from a LNG carrier to the LNG vessel according to some embodiments of the present disclosure.

FIG. 10 illustrates a schematic diagram for a system for re-condensing boil-off gas in onshore facilities or onshore transport according to some embodiments of the present disclosure.

FIG. 11 illustrates a flow chart of the method for re-condensing BOG according to some embodiments of the present disclosure.

### DETAILED DESCRIPTION

A new LNG vessel having a new configuration is described. The new configuration allows for the LNG vessel to carry smaller shipments of LNG to locations that have limited access including rivers and shallow harbors with a low water depth. The new configuration of the LNG vessel includes a bilobe or other C-type LNG storage tank, at least one LNG vaporizer, at least one water pump, and at least one LNG pump system on the main cargo platform.

The LNG vessel has the capability to handle boil-off gas. Heat slowly affects the tanks of large LNG carriers, which can cause LNG inside these tanks to evaporate and produce BOG, increasing the tank pressure in the large LNG carriers. The LNG vessel has a system for re-condensing BOG to deal with this BOG. The LNG vessel, through the system for re-condensing BOG, is able to transfer the BOG from a LNG carrier to its own LNG storage tank at a lower portion of the LNG storage tank. The LNG storage tank has an initial cargo of LNG and the transferred BOG mixes with the initial cargo of LNG. LNG from the large LNG carrier is then transferred to an upper portion of the LNG storage tank and sprinkled down onto the BOG at the lower portion of the LNG storage tank, thereby re-condensing the BOG into liquid form. In other words, BOG from the LNG carrier is bubbled through a lower part of the LNG storage tank, through existing LNG sitting in the lower portion of the LNG storage tank, which allows some re-condensing of the BOG and warming of the initial cargo of LNG. Thereafter, LNG is transferred from the LNG carrier to an upper portion of the LNG storage tank and sprinkled down onto the now warmer LNG sitting in the lower portion of the tank, thereby cooling the LNG sitting in the lower portion of the LNG storage tank and re-condensing any remaining BOG into liquid form.

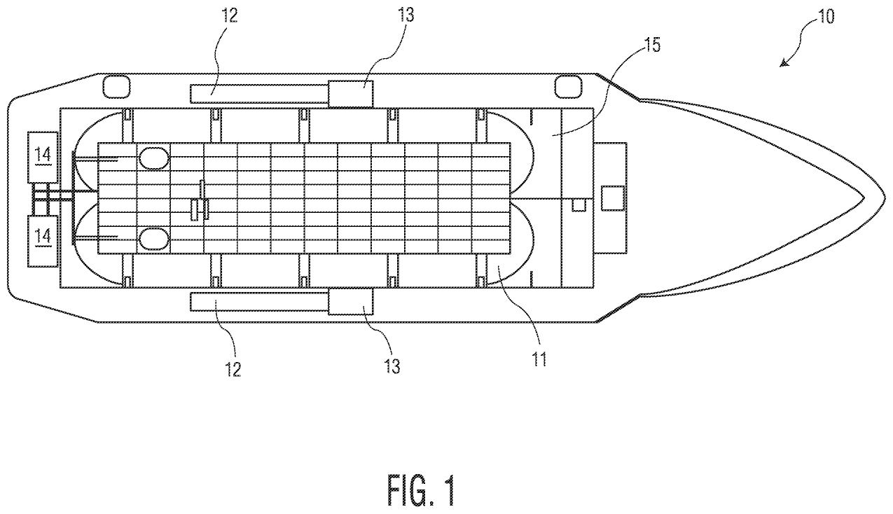

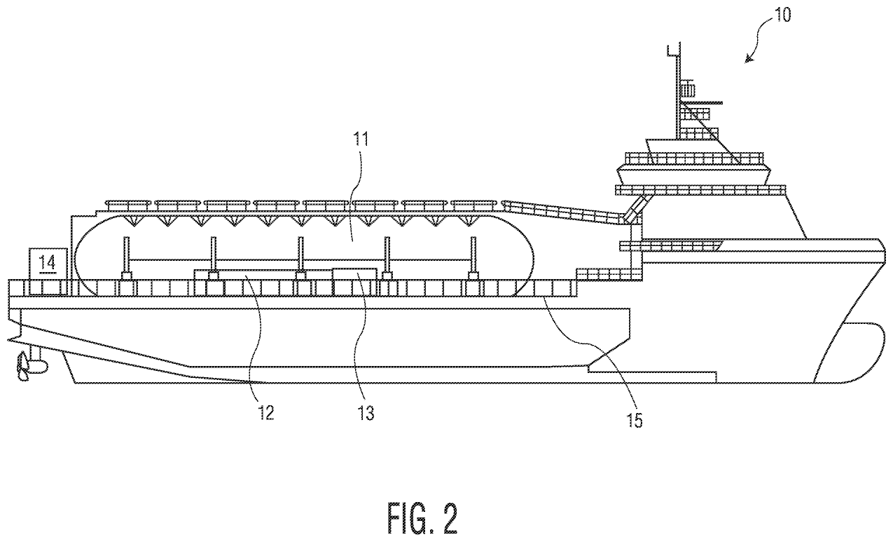

Referring to FIGS. 1 and 2, a liquefied natural gas vessel 10 is shown. The liquefied natural gas vessel 10 is a vessel that is capable of traveling short or long distances under its own power, and may utilize a steam propulsion plant, a diesel engine, diesel electric engine, a hybrid battery engine with diesel or gas, a gas turbine propulsion plant, or any other ship propulsion system known to those skilled in the art. The liquefied natural gas vessel 10 includes a bilobe or other C-type LNG storage tank 11, at least one LNG vaporizer 12, at least one water pump 13, and at least one LNG pump system 14 on the main cargo platform 15. In some embodiments, the liquefied natural gas vessel 10 is a platform support vessel (PSV) that is retrofitted to include a bilobe or other C-type LNG storage tank 11, at least one LNG vaporizer 12, at least one water pump 13, and at least one LNG pump system 14 on the main cargo platform 15.

Advantageously, retrofitting a platform support vessel (PSV) to include a bilobe or other C-type LNG storage tank 11, at least one LNG vaporizer 12, at least one water pump 13, and at least one LNG pump system 14 on the main cargo platform 15 simplifies the installation of these elements on a vessel, facilitates the speed of installation, and decreases the cost of retrofitting a vessel with these elements. This is commercially important to enable vessels to provide supply chain solutions to power plant developers, utilities, or bunkering customers who are delivering downstream assets faster than a traditional shipping new build (18 to 24 or more months), can deliver.

In some embodiments, as shown in FIGS. 1 and 2, a first LNG vaporizer 12 and a first water pump 13 are positioned on the port side of the main cargo platform 15 and a second LNG vaporizer 12 and a second water pump 13 are positioned on the starboard side of the main cargo platform 15. For some embodiments, the at least one LNG pump system 14 is positioned at the stern of the LNG vessel 10 on the main cargo platform 15. Preferably, the LNG vessel 10 pump system 14 positioned at the stern of the LNG vessel 10 on the main cargo platform 15. Each pump system 14 can include two pumps for the loading and offloading of LNG.

In some embodiments, the bilobe or other C-type LNG storage tank 11 can be a container that is configured to store liquefied natural gas and vapor, e.g., boil-off gas. Natural gas can be kept in liquid form, e.g., LNG, by maintaining its temperature below a boiling point, which is approximately −163° C. at ambient pressure. For some embodiments, the LNG storage tank can be a trilobe LNG storage tank. In some embodiments, the LNG storage tank can include more than three lobes. For exemplary purposes, the LNG storage tank 11 is described as a bilobe or other C-type LNG storage tank.

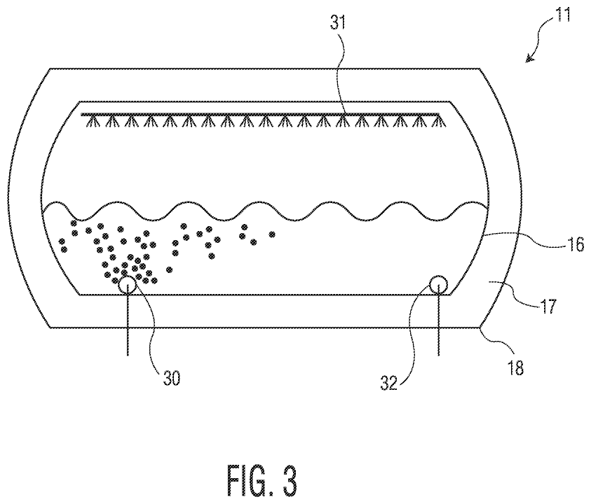

In some embodiments, the bilobe or other C-type LNG storage tank 11 can be a single insulated (with polyurethane or alternative foam insulation), double-insulated and/or a vacuum sealed tank. Preferably, the bilobe or other C-type LNG storage tank 11 is a double-insulated and vacuum sealed tank as shown in FIG. 3. The bilobe or other C-type LNG storage tank 11 can include an inner vessel 16, vacuum composite insulation 17, and an outer vessel 18. The space holding the LNG is formed by the inner vessel 16 that is made of a cold resistant material. The expression “cold resistant material” refers to a material that can withstand the temperature of liquefied natural gas. Minimum design temperature of the material should be at most −165° C. The material can be, for instance, stainless steel. Suitable materials are, for instance, 6-9% nickel steel, low manganese steel, austenitic steels, such as SA 240 type 201LN, 304, 304L, 316, 316L, 321 and 347 and austenitic Fe—Ni alloy (36% nickel). The vacuum composite insulation 17 is arranged around the inner vessel 16. The vacuum composite insulation 17 can be made of, for instance, perlite. The outer vessel 18 can be made of, for instance, carbon steel or stainless steel.

The bilobe or other C-type LNG storage tank 11 may be of any carrying capacity, preferably, less than 15,000 m³. For some embodiments, the bilobe or other C-type LNG storage tank 11 has a carrying capacity of 2,720 m³, 3,963 m³, or 4,000 m³. The bilobe or other C-type LNG storage tank 11 can also be designed to withstand pressure up to at least about 1.0 barg to about 12 barg. In contrast, conventional storage tanks are designed to withstand pressure up to about 0.25 barg, or in the special design, up to 0.7 barg. Without being bound to any specific theory, it is thought that because the bilobe or other C-type LNG storage tank 11 is able to withstand pressure up to at least about 1.0 barg to about 12 barg, BOG can be rapidly cooled and re-condensed into liquid form (LNG) in the bilobe or other C-type LNG storage tank 11.

In some embodiments, the bilobe or other C-type LNG storage tank 11 further includes internal baffles for mitigating sloshing of the LNG. For some embodiments, the internal baffles are a plurality of bulkheads that partition the space in the bilobe or other C-type LNG storage tank 11 into smaller compartments to reduce sloshing of the LNG liquid and thereby improve stability. In some embodiments, the bulkheads include a plurality of through-holes that allow LNG to flow between compartments at a controlled and safe velocity. The plurality of through-holes are dispersed differently in each bulkhead to prevent identical flow through from bulkhead o bulkhead.

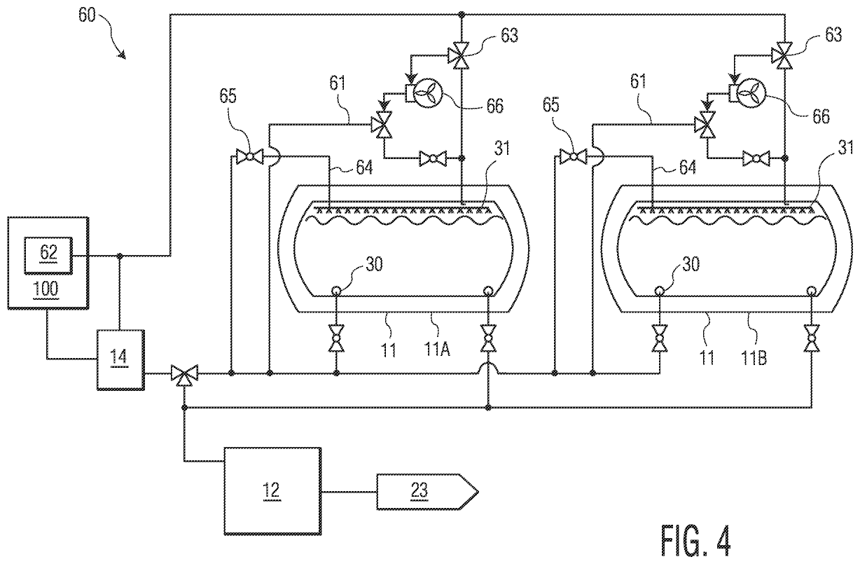

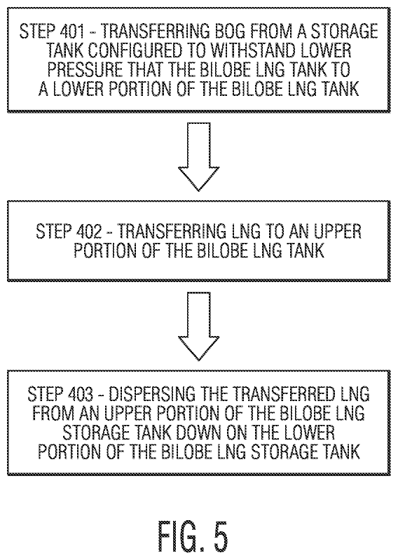

FIG. 3 provides a cross-section view of the bilobe or other C-type LNG storage tank 11 according to some embodiments of the present disclosure. For some embodiments, the bilobe or other C-type LNG storage tank 11 may further include a boil-off gas injection nozzle 30 and a plurality of LNG sprinklers 31. The plurality of LNG sprinklers 31 can be disposed in a line along an upper portion of the bilobe or other C-type LNG storage tank 11. Preferably, the plurality of LNG sprinklers 31 are disposed longitudinally along the bilobe or other C-type LNG storage tank 11 as illustrated in FIG. 3. For some embodiments, the plurality of LNG sprinklers 31 are disposed latitudinally along the bilobe or other C-type LNG storage tank 11. The BOG injection nozzle 30 can be disposed in a lower portion of the bilobe or other C-type LNG storage tank 11. The bilobe or other C-type LNG storage tank 11 can be provided with an initial cargo of LNG. The BOG injection nozzle 30 is configured to allow BOG transferred from a LNG carrier into a lower portion of the bilobe or other C-type LNG storage tank 11 having the initial cargo of LNG. Once the bilobe or other C-type LNG storage tank 11 reaches a sufficient but safe pressure, e.g., about 1.0 barg to about 12 barg, the plurality of sprinklers 31 are configured to disperse LNG transferred from a LNG carrier from an upper portion of the bilobe or other C-type LNG storage tank 11 down on the lower portion of the bilobe or other C-type LNG storage tank 11. In this way, the BOG is rapidly and sufficiently cooled such that it re-condenses any BOG back into liquid (LNG). The re-condensing system and the method for re-condensing BOG will be discussed in further detail below in connection with FIGS. 4 and 5.

The bilobe or other C-type LNG storage tank 11 further includes a LNG outlet 32. The LNG outlet 32 is configured to allow for LNG in the bilobe or other C-type LNG storage tank 11 to be transferred to the LNG vaporizers 12 such that the LNG can be re-gasified into natural gas.

Also described herein is a liquefied natural gas vessel 10 that includes a BOG re-condensing system 60 according to some embodiments of the disclosure. In some embodiments, the LNG vessel 10 described in some of the embodiments above (e.g., a LNG vessel that includes a bilobe or other C-type LNG storage tank, at least one LNG vaporizer, at least one water pump, and at least one LNG pump system on the main cargo platform) further includes the BOG re-condensing system 60. In some embodiments, The BOG re-condensing system 60 can include a first valve 63, a first set of flexible or rigid connections 61, a second valve 65, a second set of flexible or rigid connections 64, and a blower 66, as shown in FIG. 4. The valves 63, 65 are adapted for cryogenic services and can be one that is well known in the art. The valve 63 is configured to provide fluid communication between a storage tank 62 of the LNG carrier 100 and the first set of flexible or rigid connections 61. The valve 65 is configured to provide fluid communication between the pump system 14 configured to load and offload LNG and the second set of flexible or rigid connections 64. As clearly shown in FIG. 4, the BOG re-condensing system includes a valve 63, a first set of flexible or rigid connections 61, a second valve 65, a second set of flexible or rigid connections 64, and a blower 66 for each of the lobes 11A, 11B of the bilobe or other C-type LNG storage tank 11.

For some embodiments, the first set of flexible or rigid connections 61 is configured to transfer BOG from a storage tank 62 of the LNG carrier 100 to be deposited in the bilobe or other C-type LNG storage tank 11. In some embodiments, the first set of flexible or rigid connections 61 only transfers BOG. Various arrangements of fluid conduits may be used for the first set of flexible or rigid connections 61 to transfer the BOG and are well known in the art.

For some embodiments, a low pressure BOG compressor of the LNG carrier 100 is used to transfer BOG to the BOG re-condensing system 60. Various low pressure BOG compressors can be used as the low pressure BOG compressor of the LNG carrier 100 and are well known in the art.

The second valve 65 provides fluid communication between the pump system 14 (receiving LNG from the storage tank 62 of the LNG carrier 100) and a second set of flexible or rigid connections 64 configured to transfer LNG from the storage tank 62 of the LNG carrier 100 to be deposited in the lobes 11A, 11B of the bilobe or other C-type LNG storage tank 11. In some embodiments, the second set of flexible or rigid connections 64 only transfers LNG. Various arrangements of fluid conduits may be used for the second set of flexible or rigid connections 64 to transfer the LNG and are well known in the art.

The storage tank 62 is configured to withstand lower pressure than the bilobe or other C-type LNG storage tank 11. For some embodiments, the storage tank 62 are adapted to withstand pressure up to about 0.25 barg, or in the special design, up to 0.7 barg. In contrast, the bilobe or other C-type LNG storage tank 11 is adapted to withstand pressure up to at least about 1.0 barg to about 12 barg. In this way, the storage tank 62 is able transport LNG and substantially withstand the pressure generated by BOG and not treat the BOG.

The storage tank 62 can have any LNG storage capacity known in the art. For some embodiments, the storage tank 62 has an LNG storage capacity or volume of about 100,000 m³ or more. In some embodiments, the storage capacity is greater than about 50,000 m³. In certain embodiments, the storage capacity is about 50,000 m³, about 70,000 m³, about 80,000 m³, about 90,000 m³, about 100,000 m³, about 110,000 m³, about 120,000 m³, about 130,000 m³, about 150,000 m³, about 170,000 m³, about 200,000 m³ or about 300,000 m³. For some embodiments, the storage tank 62 has an LNG storage capacity of about 4,000 m³.

For some embodiments, a transfer pump is configured to transfer the BOG from the storage tank 62 of the LNG carrier 100 (configured to withstand lower pressure than the bilobe or other C-type LNG storage tank 11) to the bilobe or other C-type LNG storage tank 11 and increase the pressure of the BOG up to about 1.0 barg in the bilobe or other C-type LNG storage tank 11 (configured to withstand higher pressure than the storage tank 62 of the LNG carrier 100). The transfer pump for transferring the BOG from the storage tank 62 of the LNG carrier 100 to the bilobe or other C-type LNG storage tank 11 can be a pump in the pump system 14 on the main cargo platform 15 of the LNG vessel 10.

For some embodiments, the BOG re-condensing system 60 includes a blower 66 that is configured to push the BOG through the first set of flexible or rigid connections 61 to a lower portion of the bilobe or other C-type LNG storage tank 11, increasing the pressure of the BOG up to about 1.0 barg to 12 barg in the bilobe or other C-type LNG storage tank 11 (configured to withstand higher pressure than the storage tank 62 of the LNG carrier 100). For some embodiments, the blower 66 is also configured to push the BOG to an upper portion of the bilobe or other C-type LNG storage tank 11, which would also increase the pressure in the bilobe or other C-type LNG storage tank 11.

Preferably, the first set of flexible or rigid connections 61 is configured to provide fluid communication with a lower portion of the bilobe or other C-type LNG storage tank 11 through the BOG injection nozzle 30 disposed at the lower portion of the bilobe or other C-type LNG storage tank 11. Because the bilobe or other C-type LNG storage tank 11 has an initial cargo of LNG, the BOG that is transferred from the storage tank 62 of the LNG carrier 100 is mixed with the initial cargo of LNG.

Preferably, the second set of flexible or rigid connections 64 is configured to provide fluid communication with an upper portion of the bilobe or other C-type LNG storage tank 11 through the plurality of sprinklers 31 disposed in an upper portion of the bilobe or other C-type LNG storage tank 11. When the pressure is increased to about 1.0 barg to about 12 barg in the bilobe or other C-type LNG storage tank 11 by the introduction of BOG, the transfer pump is configured to move LNG from the storage tank 62 of the LNG carrier 100 to be deposited in the bilobe or other C-type LNG storage tank 11 by a plurality of sprinklers 31. For some embodiments, the transfer pump is a pump on the LNG carrier 100. For some embodiments, the transfer pump is part of the pump system 14 provided at the stern of the LNG vessel 10 as shown in FIGS. 1 and 2.

The plurality of sprinklers 31 is configured to sprinkle LNG transferred from the LNG carrier 100 from an upper portion of the bilobe or other C-type LNG storage tank 11 down on the lower portion of the bilobe or other C-type LNG storage tank 11. In this way, the BOG is rapidly and sufficiently cooled such that it re-condenses back into liquid (LNG). At the end of this operation, the pressure in the bilobe or other C-type LNG storage tank 11 is reduced to a standard operational pressure. For example, pressure in the bilobe or other C-type LNG storage tank 11 can be increased to about 1.0 barg before the plurality of sprinklers 31 sprinkle LNG from an upper portion of the bilobe or other C-type LNG storage tank 11 down on the lower portion of the bilobe or other C-type LNG storage tank 11 to re-condense any BOG back into liquid LNG, thereby reducing pressure in the bilobe or other C-type LNG storage tank 11 to about 0.3 barg. For some embodiments, pressure in the bilobe or other C-type LNG storage tank 11 can be increased to about 25.0 barg before the plurality of sprinklers 31 sprinkle LNG from an upper portion of the bilobe or other C-type LNG storage tank 11 down on the lower portion of the bilobe or other C-type LNG storage tank 11 to re-condense any BOG back into liquid LNG, thereby reducing pressure in the bilobe or other C-type LNG storage tank 11 to a standard operational pressure of the bilobe or other C-type LNG storage tank, e.g., 10.0 barg.

Also described herein is a method for re-condensing BOG. FIG. 5 illustrates a flow chart of the method for re-condensing BOG according to some embodiments of the present disclosure. The method for re-condensing BOG includes a step 401 of transferring BOG from a storage tank 62 configured to withstand lower pressure than the bilobe or other C-type LNG tank 11 to a lower portion of the bilobe or other C-type LNG tank 11. For some embodiments, transferring BOG to the lower portion of the bilobe or other C-type LNG tank includes using a blower 66 to transfer BOG from the storage tank 62 of the LNG carrier 100 through the first set of flexible and rigid connections 64 configured to provide fluid communication to a lower portion of the bilobe or other C-type LNG tank 11 via the BOG injection nozzle 30. In some embodiments, the first set of flexible or rigid connections 61 is configured to only transfer BOG. For some embodiments, about 1.0 barg or more can be transferred to the lower portion of the bilobe or other C-type LNG tank 11 to be mixed with an initial cargo of LNG in the bilobe or other C-type LNG tank 11.

The method for re-condensing BOG further includes a step 402 includes transferring LNG to an upper portion of the bilobe or other C-type LNG tank 11. For some embodiments, transferring LNG to an upper portion of the bilobe or other C-type LNG tank 11 includes using a transfer pump of the pump system 14 to transfer LNG from the storage tank 62 of the LNG carrier 100 through the valve 65 and the second set of flexible and rigid connections 64 configured to provide fluid communication with an upper portion of the bilobe or other C-type LNG storage tank 11. For some embodiments, transferring LNG to an upper portion of the bilobe or other C-type LNG tank 11 is performed when the pressure in the bilobe or other C-type LNG tank 11 has built up to about 1.0 barg to about 12 barg.

The method for re-condensing BOG further includes a step 403 of dispersing the transferred LNG from an upper portion of the bilobe or other C-type LNG storage tank 11 down on the lower portion of the bilobe or other C-type LNG storage tank 11. Preferably, dispersing the transferred LNG is provided by a plurality of sprinklers 31 disposed on an upper portion of the bilobe or other C-type LNG storage tank 11. The BOG in the bilobe or other C-type LNG storage tank 11 is rapidly and sufficiently cooled such that it re-condenses back into liquid (LNG). At the end of this operation, the pressure in the bilobe or other C-type LNG storage tank 11 is reduced to a standard operational pressure, e.g., to about 0.3 barg.

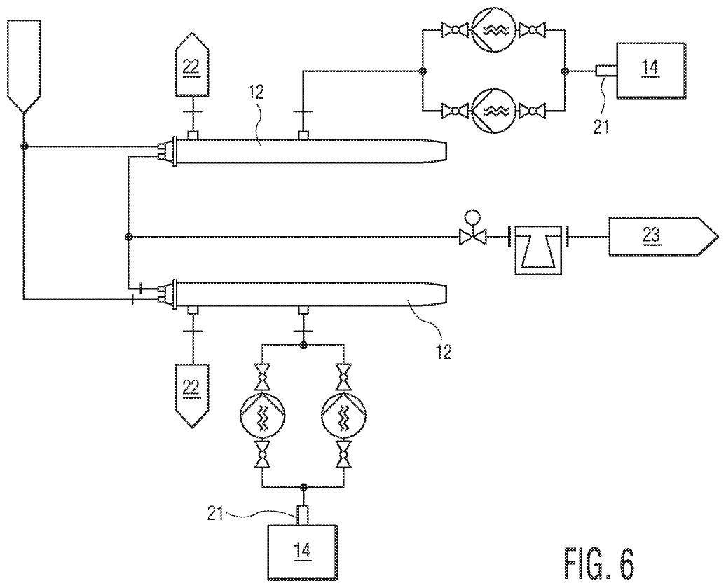

During the production of natural gas, high-pressure pumps may transfer LNG from the bilobe or other C-type LNG storage tank 11 to one or more LNG vaporizers 12, also referred to as heaters or heat exchangers. For example, the high-pressure pumps can be the pumps provided on the pump systems 14 as shown in FIGS. 1-2. LNG may be vaporized at high pressures in the LNG vaporizers 12. In some embodiments, LNG may be vaporized as schematically illustrated in FIG. 6. LNG may be pumped, utilizing low pressure pumps (not shown) that may be in LNG storage tank 11, to a recondenser and then, utilizing pumps, preferably high pressure pumps, the LNG may be pumped to LNG vaporizers 12. The LNG vaporizers 12 are configured to regasify the LNG into natural gas that can be transferred to a natural gas pipeline through outlet 23. Examples of suitable LNG vaporizers 12 include open rack vaporizers (ORVs), submerged combustion vaporizers (SCVs), shell-and-tube vaporizers (STVs), intermediate fluid vaporizers (IFVs), air vaporizers, and combinations thereof. LNG vaporizers 12 may have a heating medium inlet 21 and heating medium outlet 22 appropriate for the heating requirements of the LNG vaporizers 12. Preferably, the one or more vaporizers 12 is a shell-and-tube vaporizer.

Seawater, fresh water, and combinations thereof may be used as the heating medium for the one or more LNG vaporizers 12. The LNG vaporizers 12 may use water from the body of water the liquefied natural gas vessel 10 is positioned in to vaporize LNG in a once-through configuration. Water pumps 14 may deliver water to the LNG vaporizers 12 from a water intake system. Intake screens, velocity, location, and/or orientation may be selected to minimize marine life entrainment and impingement. The water may be treated to minimize marine growth within the water intake system. A water intake and outlet system may be installed to circulate the required volume of water from the body of water, through the facilities on the main cargo platform, and back to the body of water.

For some embodiments, an open-loop mode may be used to regasify the LNG. In an open-loop mode, sea water may be drawn in through the water pumps. The seawater may be used as a heat source and passed through the LNG vaporizers 12, preferably, tubes of shell-and-tube vaporizers. For some embodiments, engine heat can also be provided as a heat source to facilitate the regasification process. As shown in FIGS. 1 and 2, the LNG vessel 10 includes a LNG vaporizer 12 and a water pump 14 on the main cargo platform 15 on both the port side and starboard side of the LNG vessel 10. The system can also operate using close loop glycol fluid from a warm source or engine cooling system.

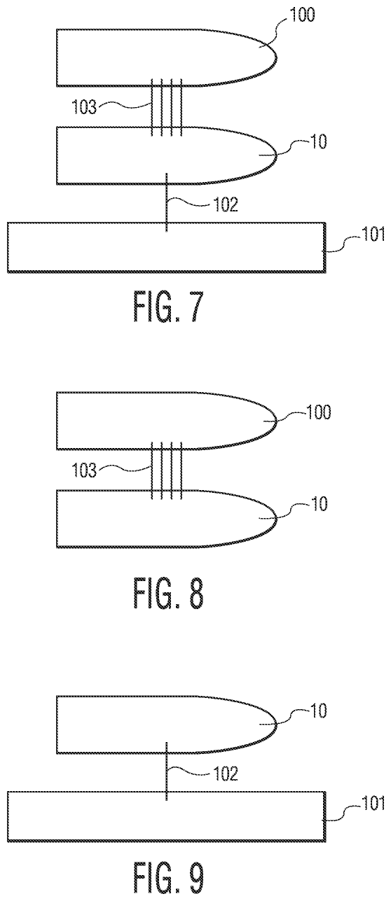

Also described herein is a system for transferring LNG from a LNG carrier to a LNG vessel and providing the regasified natural gas to onshore facilities via a gas pipeline. FIG. 7 depicts a schematic diagram for a system for transferring LNG from a LNG carrier 100 to a LNG vessel 10 and providing the regasified natural gas to onshore facilities via the gas pipeline 102 of some embodiments. The LNG vessel 10 and/or LNG carrier 100 may be coupled to dock 101. As illustrated in FIG. 7, the LNG vessel 10 is coupled to dock 101 and the LNG carrier 100 is moored to the LNG vessel 10, such that there is a side-by-side transfer of liquefied natural gas. For some embodiments, the dock 101 can be a dock, a jetty, or any other known platform/ramp for mooring ships.

LNG may be transferred from the LNG carrier 100 to the LNG vessel 10 by flexible or rigid connections 103. The connections 103 may be flexible or rigid, and may comprise using flexible cryogenic hoses, hose saddles, emergency quick release couplings and/or emergency shut down and emergency release systems. Various other arrangements are known in the art.

Coupling of the LNG vessel 10 and/or LNG carrier 100 to the dock 101 may be done using known methods for mooring a vessel to the dock 101. For example, the LNG vessel 10 may be fastened to the dock 101 by using ropes, mooring lines, hawsers, fenders, anchors, and/or buoys. Additional safety features may also be included in the mooring systems so that the LNG vessel 10 and/or LNG carrier 100 may be safely moored at the dock 101. For example, the mooring system may include mooring line hooks with load sensors, automated mooring strain gauge systems with alarms, remote release capabilities and/or quick release capabilities. In addition, provisions for tug boat assistance during mooring and timely access to tugs during periods of bad weather may be incorporated and improve the safety of the mooring system. Recommendations from Hazard Operability Studies (HAZOP) and Hazard Identification (HAZID) risk assessments may also be included in the mooring systems.

Dock 101 may extend any distance from the that allows the LNG vessel 10 to proceed to the dock, lay alongside the dock, and depart from the dock, while always staying afloat. Dock 101 may be reinforced with concrete and bridge decking to accommodate the regasification and delivery of natural gas. Shorter distances from the shoreline to the end of the dock allow minimization of the length of piping needed to transfer the natural gas to shore, such as the length of gas pipeline 102. Dock 101 may be in a protected area of the shoreline. Docking of the vessels in a protected area may allow transfer of LNG, regasification of LNG, and subsequent transfer of regasified natural gas to be carried out in non-ideal weather conditions. For example, water (seas) near the dock may be calmer than water (seas) one or two miles offshore of the dock.

FIGS. 8 and 9 depict a schematic diagrams for transferring LNG from a LNG carrier 100 to a LNG vessel 10 and providing the re-gasified natural gas to onshore facilities via the gas pipeline 102 according to some embodiments of the present disclosure. As illustrated in FIG. 8, the LNG vessel 10 and the LNG carrier 100 may be coupled together offshore to transfer LNG from the LNG carrier 100 to the LNG vessel 10. LNG may be transferred from the LNG carrier 100 to the LNG vessel 10 by flexible or rigid connections 103. The connections 103 may be flexible or rigid, and may comprise using flexible cryogenic hoses, hose saddles, emergency quick release couplings and/or emergency shut down and emergency release systems. Various other arrangements are known in the art

As illustrated in FIG. 9, the LNG vessel 10 after receiving the LNG from the LNG carrier 100 travels to dock 101 and is coupled to dock 101, wherein the LNG vessel 10 provides regasified natural gas to onshore facilities via the gas pipeline 102. Coupling of the LNG vessel 10 to the dock 101 may be done using known methods for mooring a vessel to the dock 101 as previously discussed herein.

The LNG vessel 10 and the LNG carrier 100 may be coupled using techniques known to those in the art to facilitate ship-to-ship transfer of LNG. For example, the LNG vessel 10 and the LNG carrier 100 may be coupled using mooring facilities and fendering equipment. LNG may be transferred from LNG carrier 100 to the LNG vessel 10 via flexible or rigid connections 103. Connections 103 may be flexible or rigid, and may comprise using flexible cryogenic hoses, hose saddles, emergency quick release couplings and/or emergency shut down and emergency release systems. Boil-off gas may be managed by ship-to-ship transfer. The transferred LNG may be treated onboard the regasification vessel to form re-gasified natural gas as previously discussed herein. The re-gasified natural gas may be transferred to dock 101 via gas pipeline 102, which may be coupled to onshore facilities.

Piping, such as the flexible or rigid connections 103 and gas pipeline 102, carrying the streams and connecting elements of the systems is well known to those of skill in the art and thus is not described in detail herein so as not to obscure the present disclosure. As previously discussed, LNG may be transferred from LNG carrier 100 to the LNG vessel 10 via piping (flexible or rigid connections 103) and re-gasified natural gas may be transferred to dock 101 via piping (gas pipeline 102).

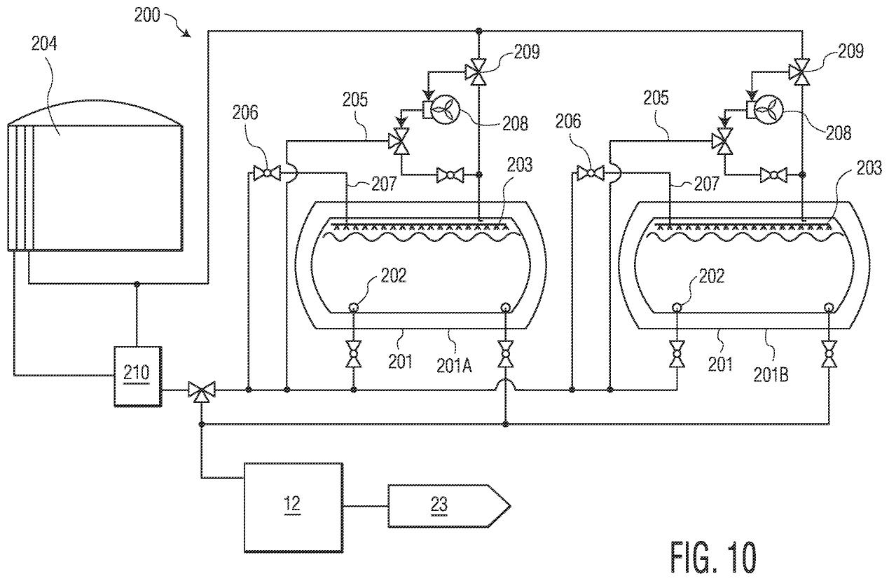

Also described herein is a re-condensing system that can be used in onshore facilities or onshore operations. FIG. 10 illustrates the re-condensing system that can be used in onshore facilities or onshore operations of some embodiments. In some embodiments, a re-condensing system 200 can be used in onshore facilities or onshore operations, e.g., road transportation of LNG, as opposed to maritime transportation of LNG. The re-condensing system 200 can include a LNG storage tank 201 designed to withstand pressure up to at least about 1.0 barg to about 12 barg, and a LNG storage tank 204 that is adapted to withstand pressure up to about 0.25 barg, or in the special design, up to 0.7 barg. Without being bound to any specific theory, it is thought that because the LNG storage tank 201 is able to withstand pressure up to at least about 1.0 barg to about 12 barg, BOG can be rapidly cooled and re-condensed into liquid form (LNG) in the LNG storage tank 201.

For some embodiments, the LNG storage tank 201 is a single-insulated, double-insulated, and/or a vacuum sealed tank as described herein. For some embodiments, the LNG storage tank 201 is a bilobe or other C-type LNG storage tank having lobes 201A, 201B. In other embodiments, the LNG storage tank 201 is a bilobe or other C-type LNG storage tank and a vacuum sealed tank as previously described herein. The LNG storage tank 201 may be of any carrying capacity, preferably, less than 15,000 m³. For some embodiments, the LNG storage tank 201 has a carrying capacity of 2,720 m³, 3,963 m³, or 4,000 m³.

For some embodiments, each of the lobes 201A, 201B of the LNG storage tank 201 can include a boil-off gas injection nozzle 202 and a plurality of LNG sprinklers 203. The plurality of LNG sprinklers 203 can be disposed in a line along an upper portion of the LNG storage tank 201. For some embodiments, the plurality of LNG sprinklers 203 are disposed longitudinally along the LNG storage tank 201 as illustrated in FIG. 3. For some embodiments, the plurality of LNG sprinklers 203 are disposed latitudinally along the LNG storage tank 201. The BOG injection nozzle 203 can be disposed in a lower portion of the LNG storage tank 201.

The LNG storage tank 201 is provided with an initial cargo of LNG before any BOG is transferred into the LNG storage tank 201. The BOG injection nozzle 202 is configured to allow BOG transferred from another LNG storage tank 204 into a lower portion of the LNG storage tank 201 having the initial cargo of LNG. Once the LNG storage tank 201 reaches a sufficient pressure, e.g., about 1.0 barg to about 12 barg, the plurality of sprinklers 203 are configured to sprinkle LNG (transferred from the second LNG storage tank 204) from an upper portion of the LNG storage tank 201 down on the lower portion of the LNG storage tank 201. In this way, the BOG is rapidly and sufficiently cooled such that it re-condenses back into liquid (LNG).

The re-condensing system 200 includes a first valve 209, a first set of flexible or rigid connections 205, a second valve 206, a second set of flexible or rigid connections 207, and a blower 208. For some embodiments, there is a first valve 209, a first set of flexible or rigid connections 205, a second valve 206, a second set of flexible or rigid connections 207, and a blower 208 dedicated to lobe 201A and a second set dedicated to lobe 201B, as shown in FIG. 10. The first valve 209 is configured to provide fluid connection between the second LNG storage tank 204 and the first set of flexible or rigid connections 205. In some embodiments, the first set of flexible or rigid connections 205 is configured to transfer BOG from the second LNG storage tank 204 to the LNG storage tank 201. In some embodiments, the first set of flexible or rigid connections 205 only transfers BOG. Various arrangements of fluid conduits may be used for the first set of flexible or rigid connections 205 to transfer the BOG and are well known in the art.

Preferably, the first set of flexible or rigid connections 205 is configured to provide fluid communication with a lower portion of the first LNG storage tank 201 through the BOG injection nozzle 202 disposed at the lower portion of the first LNG storage tank 201 via the blower 208. The blower 208 is configured to transfer BOG from the second LNG storage tank 204 to the lower portion of the first LNG storage tank 201. Because the first LNG storage tank 201 has an initial cargo of LNG, the BOG that is transferred from the second LNG storage tank 204 is mixed with the initial cargo of LNG, thereby warming the initial cargo of LNG and re-condensing some of the transferred BOG into liquid form (LNG).

The second valve 206 is configured to provide fluid communication between the second LNG storage tank 204 and the second set of flexible or rigid connections 207 via a pump system 210. The second set of flexible or rigid connections 207 are configured to transfer LNG from the second LNG storage tank 204 to be deposited in the first LNG storage tank 201. In some embodiments, the second set of flexible or rigid connections 207 only transfers LNG. Various arrangements of fluid conduits may be used for the first set of flexible or rigid connections 205 to transfer the BOG and are well known in the art.

Preferably, the second set of flexible or rigid connections 207 are configured to provide fluid communication with an upper portion of the first LNG storage tank 201 through the plurality of sprinklers 203 disposed in an upper portion of the first LNG storage tank 201. When the pressure of the BOG is increased to about 1.0 barg to about 12 barg in the first LNG storage tank 201, a transfer pump of the pump system 210 is configured to move LNG from the second LNG storage tank 204 to be deposited in the first LNG storage tank 201 by a plurality of sprinklers 203. That is, the transfer pump of the pump system 210 is configured to transfer the LNG from the second storage tank 204 (configured to withstand lower pressure than the first LNG storage tank 201) to the first LNG storage tank 201 (configured to withstand higher pressure than the second storage tank 204) to reduce the pressure in the first storage tank 201 caused by the BOG.

The plurality of sprinklers 203 are configured to sprinkle LNG transferred from the second LNG storage tank 204 from an upper portion of the first LNG storage tank 201 down on the lower portion of the first LNG storage tank 201. In this way, the BOG is rapidly and sufficiently cooled such that it re-condenses back into liquid (LNG). At the end of this operation, the pressure in the first LNG storage tank 201 is reduced to an operational pressure of the first LNG storage tank 201. For some embodiments, the pressure in the LNG storage tank can be reduced to about 0.3 barg.

The second storage tank 204 is configured to withstand lower pressure than the first LNG storage tank 201. In some embodiments, the second LNG storage tank 204 is configured to withstand pressure up to about 0.25 barg, or in the special design, up to 0.7 barg. In contrast, the first LNG storage tank 201 is adapted to withstand pressure up to at least about 1.0 barg to about 2.0 barg. In this way, the first storage tank 201 is able transport LNG (if necessary) and substantially withstand the pressure generated by BOG and not treat the BOG. For some embodiments, the second storage tank 204 has an LNG storage capacity or volume about 100,000 m³ or more. In some embodiments, the storage capacity is greater than about 50,000 m³. In certain embodiments, the storage capacity is about 50,000 m³, about 70,000 m³, about 80,000 m³, about 90,000 m³, about 100,000 m³, about 110,000 m³, about 120,000 m³, about 130,000 m³, about 150,000 m³, about 170,000 m³, about 200,000 m³ or about 300,000 m³.

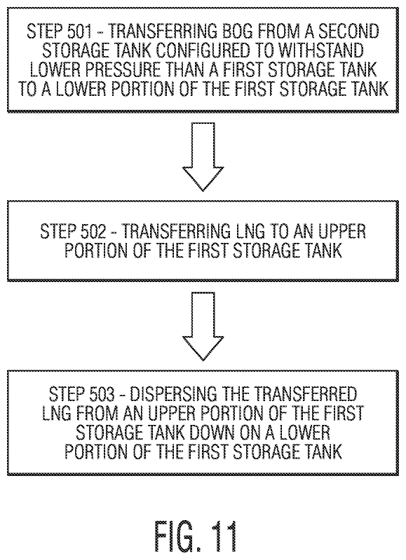

Also described herein is a method for re-condensing BOG. FIG. 11 illustrates a flow chart of the method for re-condensing BOG of some embodiments. The method for re-condensing BOG includes a step 501 of transferring BOG from a storage tank 204 configured to withstand lower pressure than a storage tank 201 to a lower portion of the storage tank 201. For some embodiments, transferring BOG to the lower portion of the storage tank 201 includes using a blower 208 to transfer BOG from the storage tank 204 through the first set of flexible and rigid connections 205 configured to provide fluid communication to a lower portion of the storage tank 201 via the BOG injection nozzle 202. The first set of flexible or rigid connections 205 is configured to only transfers BOG. For some embodiments, BOG can be transferred to the lower portion of the storage tank 201 to be mixed with an initial cargo of LNG in the storage tank 201 such that the pressure in the storage tank 201 is increased to about 1.0 barg to about 12 barg.

The method for re-condensing BOG further includes a step 502 includes transferring LNG to an upper portion of the storage tank 201. For some embodiments, transferring LNG to an upper portion of the storage tank 201 includes using a transfer pump to transfer LNG from the storage tank 204 through the second valve 206 and the second set of flexible and rigid connections 207 configured to provide fluid communication with an upper portion of the storage tank 201. For some embodiments, transferring LNG to an upper portion of the storage tank 201 is performed when the pressure in the storage tank 201 has built up to about 1.0 barg to about 12 barg.

The method for re-condensing BOG further includes a step 502 of dispersing the transferred LNG from an upper portion of the storage tank 201 down on the lower portion of the storage tank 201. For some embodiments, dispersing the transferred LNG from an upper portion of the storage tank 201 includes using a plurality of sprinklers 203 disposed along an upper portion of the storage tank 201. The BOG in the storage tank 201 is rapidly and sufficiently cooled such that it re-condenses back into liquid (LNG). At the end of this operation, the pressure in the storage tank 201 is reduced to a normal operational pressure, e.g., to about 0.3 barg.

For some embodiments, the storage tank 201 can be a bilobe or other C-type LNG storage tank as described herein.

Although described in connection with these embodiments, those of skill in the art will recognize that changes can be made in form and detail without departing from the spirit and scope of the disclosure.

1. A liquefied natural gas vessel, comprising, on the main cargo platform:
a bilobe or other C-type liquid natural gas (LNG) storage tank,
a LNG vaporizer,
a water pump, and
a LNG pump system,
wherein the LNG pump system is configured to load and offload LNG in the bilobe or other C-type LNG storage tank, and the one or more LNG vaporizer and the one or more water pump is configured to re-gasify LNG loaded in the bilobe or other C-type LNG storage tank.

2. The vessel according to claim 1, wherein the vessel includes two LNG vaporizers, wherein the first LNG vaporizer is positioned on a port side of the vessel and the second LNG vaporizer is positioned on a starboard side of the vessel.

3. The vessel according to claim 1, wherein the vessel includes two water pumps, wherein the first water pump is positioned on a port side of the vessel and the second water pump is positioned on a starboard side of the vessel.

4. The vessel according to claim 1, wherein the vessel includes two LNG pump systems, wherein the two LNG pump systems are positioned on a stern of the vessel.

5. The vessel according to claim 1, wherein the bilobe or other C-type LNG storage tank is adapted to withstand pressure up to about 1.0 barg to about 12 barg.

6. The vessel according to claim 5, wherein the bilobe or other C-type LNG storage tank includes an inner vessel, a vacuum composite insulation, and an outer vessel.

7. The vessel according to claim 5, wherein the bilobe or other C-type LNG storage tank includes a BOG nozzle and a plurality of sprinklers.

8. The vessel according to claim 7, wherein the plurality of LNG sprinklers are disposed in a line along an upper portion of the bilobe or other C-type LNG storage tank.

9. The vessel according to claim 7, wherein the boil-off gas nozzle is disposed in a lower portion of the bilobe or other C-type LNG storage tank.

10. The vessel according to claim 7, wherein the vessel further includes a system for re-condensing (boil-off gas) BOG.

11. The vessel according to claim 10, wherein the system for re-condensing BOG includes:
a first valve configured to provide fluid communication between a storage tank of a LNG carrier to a first set of flexible or rigid connections,
a second valve configured to provide fluid communication between the storage tank of the LNG carrier to a second set of flexible or rigid connections,
wherein the first set of flexible or rigid connections is configured to transfer BOG by a blower from the storage tank of the LNG carrier to be deposited in the bilobe or other C-type LNG storage tank through a BOG injection nozzle, and
the second set of flexible or rigid connections is configured to transfer LNG from the storage tank of the LNG carrier to be deposited in the bilobe or other C-type LNG storage tank by a plurality of sprinklers.

12. The vessel according to claim 11, wherein the storage tank of the LNG carrier is configured to withstand pressure of about 0.25 barg.

13. The vessel according to claim 11, wherein the storage tank of the LNG carrier is configured to withstand pressure of about 0.70 barg.

14. The vessel according to claim 11, wherein the bilobe or other C-type LNG storage tank includes an initial cargo of LNG.

15. The vessel according to claim 11, wherein the blower is configured to transfer BOG from the storage tank on the LNG carrier to a lower portion of the bilobe or other C-type LNG storage tank, increasing increase pressure in the bilobe or other C-type LNG storage tank to about 1.0 barg to about 12 barg.

16. The vessel according to claim 11, wherein a transfer pump is configured to transfer LNG from the storage tank on the LNG carrier to an upper portion of the bilobe or other C-type LNG storage tank.

17. The vessel according to claim 11, wherein the plurality of sprinklers is configured to sprinkle LNG transferred from the LNG carrier from an upper portion of the bilobe or other C-type LNG storage tank down on a lower portion of the bilobe or other C-type LNG storage tank when the pressure in the bilobe or other C-type LNG storage tank reaches about 1.0 barg to about 12 barg, thereby re-condensing BOG into liquid form.

18. The vessel according to claim 17, wherein the bilobe or other C-type LNG storage tank is reduced to a pressure of about 0.3 barg after BOG is re-condensed into liquid form.

19-42. (canceled)
